(19) United States
(12) Patent Application Publication
(10) Pub. No.: US 2026/0259873 A1
(43) Pub. Date: Sep. 3, 2026

(54) Synthetic Data Generation Via SQL-to-NL for Training NL-to-SQL Models

(71) Applicant: Oracle International Corporation, Redwood Shores, CA (US)

(72) Inventors: Mohammadtaher Safarzadeh, New York City, NY (US); Dan Roth, Philadelphia, PA (US); Sujith Ravi, Menlo Park, CA (US); Syed Fahad Allam Shah, Washougal, WA (US)

(73) Assignee: Oracle International Corporation, Redwood Shores, CA (US)

(21) Appl. No.: 19/301,212

(22) Filed: Aug. 15, 2025

Related U.S. Application Data
(60) Provisional application No. 63/764,650, filed on Feb. 28, 2025.

(51) Int. Cl. G06F 16/242

(52) U.S. Cl. CPC G06F 16/243

(57) ABSTRACT

Techniques for generating natural language (NL) queries are disclosed. The system generates NL queries that are schema-aligned, thereby mitigating linking errors during the conversion from NL queries to SQL queries. The system receives a request to generate an NL query that comprises a reference SQL query and identifies a schema. To generate the NL query from the SQL query, the system determines schema elements corresponding to the target schema and uses those schema elements to generate a schema-aligned NL query. The system provides the reference SQL query and a relevant portion of the target schema to a SQL-to-NL machine learning model that generates the NL query, taking into consideration the schema elements.

### BENEFIT CLAIMS; RELATED APPLICATIONS; INCORPORATION BY REFERENCE

This application claims the benefit of U.S. Provisional Patent Application 63/764,650, filed Feb. 28, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning (ML) models. In particular, the present disclosure relates to testing and improving the operation of ML models.

### BACKGROUND

Natural Language-to-Structured Query Language (NL-to-SQL) systems enable users to interact with databases using Natural Language Queries (NLQs). This technology translates NLQs into SQL queries, allowing users to retrieve and manipulate data in a database without needing to write SQL code. NL-to-SQL systems can be used to simplify complex data retrieval and manipulation tasks and can be integrated with various types of databases and data systems. The use of NLQs can improve the usability and accessibility of databases, making it easier for non-technical users to interact with data. NL-to-SQL systems can also be used to improve the efficiency and productivity of data analysis and manipulation tasks by allowing users to focus on their core tasks rather than on writing SQL code. Additionally, NL-to-SQL systems can be used to improve the accuracy and reliability of data retrieval and manipulation tasks by reducing the likelihood of errors caused by incorrect SQL code.

In the context of Retrieval Augmented Generation (RAG) systems, NL-to-SQL technology facilitates seamless data-driven interactions between users and databases. By abstracting away the complexities of SQL syntax, NL-to-SQL systems enable users to focus on their core tasks rather than being hindered by technical details. This can improve the overall user experience and increase the adoption and utilization of RAG systems. NL-to-SQL systems can also be used to improve the scalability and flexibility of RAG systems by allowing users to easily integrate new data sources and databases.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning (ML) engine in accordance with one or more embodiments;

FIG. 2 illustrates the operation of an ML engine in one or more embodiments;

FIG. 3 illustrates an evaluation system in accordance with one or more embodiments;

FIG. 4 illustrates an example set of operations for evaluating and improving NL-to SQL models in accordance with one or more embodiments;

FIG. 5 illustrates an example set of operations for evaluating and improving NL-to SQL models in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. GENERATIVE MODELS
4. EVALUATION SYSTEM ARCHITECTURE
5. EVALUATING AND IMPROVING NL-TO SQL MODELS
6. EXAMPLE EMBODIMENT
7. COMPUTER NETWORKS AND CLOUD NETWORKS
8. HARDWARE OVERVIEW
9. MISCELLANEOUS; EXTENSIONS

### 1. General Overview

One or more embodiments generate NLQs that are schema-aligned, thereby mitigating linking errors during the conversion from NLQs to SQL queries. The system receives a request to generate an NLQ that comprises a reference SQL query and identifies a schema. To generate the NLQ from the SQL query, the system determines schema elements corresponding to the target schema and uses those schema elements to generate a schema-aligned NLQ. The system provides the reference SQL query and a relevant portion of the target schema to a SQL-to-NL model that generates the NLQ, taking into consideration the schema elements.

An embodiment performs a validation function by generating a round-trip SQL (RTSQL) query based on the schema-aligned NLQ. The system passes the schema-aligned NLQ through a NL-to-SQL ML model that generates the RTSQL query. Since the RTSQL query is based on a schema-aligned NLQ, it may be used to determine if the NL-to-SQL model is functioning properly while ruling out the possibility of a linking error. The system compares the RTSQL query to the reference SQL query on which the schema-aligned NLQ is based to ensure that both queries have matching actual or expected execution results.

One or more embodiments described in this Specification and/or recited in the claims may not be included in this General Overview section.

### 2. Machine Learning Architecture

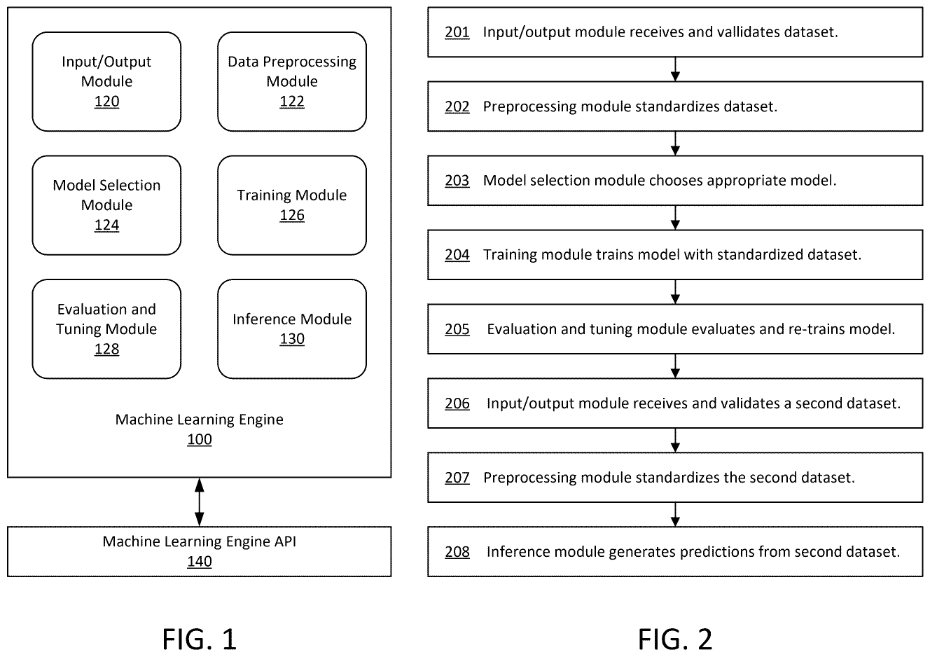

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, application programming interfaces (APIs), file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 120 receives a dataset intended for training (Operation 201). This data can originate from diverse sources, like databases or real-time data streams, and in varied formats, such as CSV, JSON, or XML. Input/output module 120 assesses and validates the data, ensuring its integrity by checking for consistency, data ranges, and types.

In an embodiment, training data is passed to data preprocessing module 122. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 122 is then fed into model selection module 124 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 126 trains the selected model with the prepared dataset (Operation 204). It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

In an embodiment, evaluation and tuning module 128 evaluates the trained model's performance using the validation dataset (Operation 205). Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 120 receives a dataset intended for inference. Input/output module 120 assesses and validates the data (Operation 206).

In an embodiment, data preprocessing module 122 receives the validated dataset intended for inference (Operation 207). Data preprocessing module 122 ensures that the data format used in training is replicated for the new inference data, maintaining consistency and accuracy for the model's predictions.

In an embodiment, inference module 130 processes the new dataset intended for inference, using the trained and tuned model (Operation 208). It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model (LLM). LLMs are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language (NL) structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

The data input to any ML model and/or the data output from any ML model, as described herein, may be used for operations performed by one or more of: Database Software, Cloud Infrastructure Software, Customer Relationship Management Software, Data Science Software, Digital Assistant Software, Vision Software, Language Software, Speech Software, Forecasting Software, Enterprise Software, Middleware, Server Software, Identity Management Software, Application Development Software, Analytics Software, Security Software, Data Integration Software, Health Software, Hospitality Software, Retail Software, Utilities Software, Operating Systems, Virtualization Software, Governance and Administration Software, Migration & Disaster Recovery Software, Networking Software, Connectivity Software, Monitoring Software, Procurement Software, Project Management Software, Risk Management Software, Supply Chain Management Software, Manufacturing Software, Human Capital Management Software, Customer Experience Software, Advertising Software, and Industry-Specific Application Software.

### 4. Evaluation System Architecture

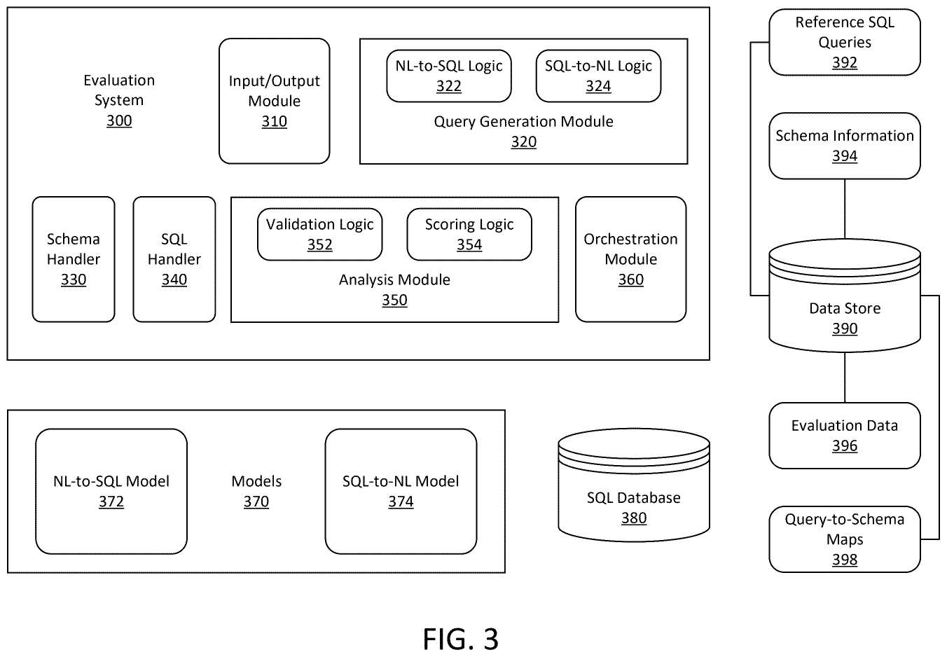

FIG. 3 illustrates an evaluation system in accordance with one or more embodiments. Evaluation system 300 evaluates the accuracy of queries generated using NL-to-SQL conversion techniques. Evaluation system 300 comprises input/output module 310, query generation module 320, schema handler 330, SQL handler 340, analysis module 350, and orchestration module 360. Query generation module 320 comprises NL-to-SQL logic 322 and SQL-to-NL logic 324. The components illustrated in FIG. 3 may be local to or remote from each other. The components illustrated in FIG. 3 may be implemented in software and/or hardware. Each component may be distributed over multiple applications and/or machines. Multiple components may be combined into one application and/or machine. Operations described with respect to one component may instead be performed by another component.

In an embodiment, evaluation system 300 operates as a framework for assessing the performance of NL-to-SQL conversion processes. Evaluation system 300 receives NLQs and corresponding database schemas as inputs, then generates SQL translations through ML models, calculating accuracy metrics and generating training data for ML models. The system processes these conversions by coordinating multiple specialized modules that handle different aspects of the evaluation workflow. Evaluation system 300 maintains connections to external model repositories, systems, and data stores to access the necessary resources for performing conversions, storing reference materials, and storing analysis and training data.

In an embodiment, evaluation system 300 orchestrates the interaction between natural language processing (NLP) components and database query generation mechanisms through a modular architecture. The system accepts test datasets including NLQs paired with database schema definitions then routes these inputs through appropriate processing modules based on the conversion direction desired. Evaluation system 300 supports bidirectional conversion capabilities, allowing for both NL-to-SQL transformations and SQL-to-NL translations within the same framework. The system coordinates timing and resource allocation across modules to manage concurrent processing of multiple query conversion requests.

In an embodiment, evaluation system 300 generates performance metrics by comparing machine-generated SQL queries against reference implementations stored in associated data repositories. The system calculates confidence scores and accuracy measurements through statistical analysis of conversion results, taking into account both syntactic correctness and semantic equivalence of generated queries. Evaluation system 300 aggregates these measurements across multiple test cases to provide comprehensive assessment reports that indicate model performance characteristics. The system maintains historical performance data to support analysis of model improvement over time and across different query complexity categories.

In an embodiment, input/output module 310 manages the ingestion of NLQs and database schema definitions that serve as test inputs for the evaluation process. Input/output module 310 receives datasets, such as those including pairs of NL statements and corresponding database structures or those including SQL queries, training data, or other query information. Input/output module 310 processes these incoming data streams and validates the format and structure of the received information before routing the data to appropriate processing components within evaluation system 300. Input/output module 310 handles multiple input formats including text files, JSON structures, and database connection parameters that specify target schemas.

In an embodiment, input/output module 310 coordinates the delivery of processed results and evaluation metrics to external systems and user interfaces. Input/output module 310 formats scoring data, confidence measurements, and comparative analysis results into standardized output formats that support integration with reporting tools and downstream applications. Input/output module 310 manages the timing and sequencing of result delivery to maintain consistency between input processing and output generation cycles. Input/output module 310 supports configurable output destinations, including file systems, network endpoints, and direct API responses based on the evaluation request parameters.

In an embodiment, input/output module 310 maintains communication channels with other modules within evaluation system 300 to coordinate data flow and processing status updates. Input/output module 310 receives processing requests from orchestration module 360 and transmits formatted input data to query generation module 320 for conversion operations. Input/output module 310 collects completed evaluation results from scoring module 350 and prepares these results for internal storage, use, or external delivery according to specified formatting requirements. Input/output module 310 tracks the processing state of individual evaluation requests and provides status information back to requesting systems or user interfaces to support monitoring of evaluation progress.

In an embodiment, query generation module 320 produces SQL queries and NL queries from multiple data sources, including historical log files, database schemas, and existing data samples. Query generation module 320 analyzes these source materials to extract patterns and structures that represent typical query usage scenarios within target database environments. Query generation module 320 constructs both NLQ statements and SQL query structures based on the analyzed patterns. Query generation module 320 may create matched pairs that serve as test cases for evaluation processes. Query generation module 320 coordinates with schema handler 330 to obtain current database structure information and incorporates this schema data into the queries to maintain consistency with target database configurations.

In an embodiment, query generation module 320 manages the conversion processes between NL and SQL formats through specialized logic components that interface with external ML models. Query generation module 320 receives conversion requests from orchestration module 360 and routes these requests to appropriate internal logic components based on the desired conversion direction. Query generation module 320 aggregates conversion results from both NL-to-SQL and SQL-to-NL processing paths then transmits the completed conversions to scoring module 350 for accuracy assessment. The module maintains conversion information and tracks processing progress for individual query pairs to support coordination with other system components during evaluation workflows.

In an embodiment, NL-to-SQL logic 322 establishes communication pathways with NL-to-SQL model 372 that resides within models 370, also shown in FIG. 3, to facilitate NLQ conversion operations. NL-to-SQL logic 322 transmits NLQ strings and associated database schema information to NL-to-SQL model 372 through API interfaces or direct function calls. NL-to-SQL logic 322 formats input data according to the specific requirements of NL-to-SQL model 372, including tokenization of NL text and serialization of schema metadata into model-compatible representations. NL-to-SQL logic 322 manages authentication and session management protocols used for secure communication with the external model repository.

In an embodiment, NL-to-SQL logic 322 processes responses received from NL-to-SQL model 372 and performs validation operations on the generated SQL query structures. The logic component parses the model output to extract SQL statements and associated confidence metrics that indicate the model's certainty regarding the conversion accuracy. NL-to-SQL logic 322 applies syntactic validation rules to verify that generated SQL queries conform to standard SQL syntax requirements and database-specific dialect constraints. NL-to-SQL logic 322 handles error conditions that may arise from model communication failures or invalid model responses, implementing retry mechanisms and fallback procedures to maintain system reliability.

In an embodiment, NL-to-SQL logic 322 coordinates the timing and sequencing of model interactions to optimize resource utilization and minimize processing latency. NL-to-SQL logic 322 manages request queuing when multiple conversion operations occur simultaneously, distributing requests across available model instances to balance computational load. NL-to-SQL logic 322 monitors model response times and adjusts request parameters, such as timeout values and batch sizes, based on observed performance characteristics. The logic component maintains conversion history and performance statistics that support system optimization and troubleshooting activities within the broader evaluation framework.

In an embodiment, SQL-to-NL logic 324 establishes communication pathways with SQL-to-NL model 374 that resides within models 370 to facilitate SQL to NLQ conversion operations. SQL-to-NL logic 324 transmits SQL query strings and associated database schema information to SQL-to-NL model 374 through API interfaces or direct function calls. SQL-to-NL logic 324 formats input data according to the specific expectations of SQL-to-NL model 374, including tokenization of query text and serialization of schema metadata into model-compatible representations. SQL-to-NL logic 324 manages authentication and session management protocols used for secure communication with the external model repository.

In an embodiment, SQL-to-NL logic 324 processes responses received from NL-to-SQL model 372 and performs validation operations on the generated NLQ structures. The logic component parses the model output to extract NLQs and associated confidence metrics that indicate the model's certainty regarding the conversion accuracy. SQL-to-NL logic 324 applies syntactic validation rules to verify that generated NLQs conform to linguistical norms. SQL-to-NL logic 324 handles error conditions that may arise from model communication failures or invalid model responses, implementing retry mechanisms and fallback procedures to maintain system reliability.

In an embodiment, SQL-to-NL logic 324 coordinates the timing and sequencing of model interactions to optimize resource utilization and minimize processing latency. SQL-to-NL logic 324 manages request queuing when multiple conversion operations occur simultaneously, distributing requests across available model instances to balance computational load. SQL-to-NL logic 324 monitors model response times and adjusts request parameters, such as timeout values and batch sizes, based on observed performance characteristics. The logic component maintains conversion history and performance statistics that support system optimization and troubleshooting activities within the broader evaluation framework.

In an embodiment, models 370 functions as a centralized repository for storing and managing ML models that support query conversion operations within evaluation system 300. Models 370 maintains version control information for the stored models, tracking model iterations, training dates, and performance characteristics across different deployment cycles. The repository provides standardized access interfaces that support model retrieval, loading, and execution requests from various system components. Models 370 implements storage optimization techniques, including model compression and caching mechanisms, to reduce memory footprint and improve access response times for frequently used models.

In an embodiment, models 370 supports concurrent access patterns that allow multiple system components to interact with stored models simultaneously without resource conflicts. The repository manages various model lifecycle operations, including deployment of new model versions, retirement of obsolete models, and rollback procedures for problematic model updates. Models 370 maintains metadata records for models that include training dataset information, accuracy metrics, and compatibility requirements with specific database schema types. The repository coordinates with external model training systems to receive updated models and integrates these updates into the active model inventory through automated deployment pipelines.

In an embodiment, models 370 provide resource allocation and load balancing capabilities that distribute model execution requests across available computational resources. The repository monitors model usage patterns and performance metrics to optimize resource allocation strategies and identify potential bottlenecks in model access workflows. Models 370 implements security controls that restrict model access based on authentication credentials and usage permissions defined within evaluation system 300. The repository maintains audit logs that track model access patterns, execution times, and result quality metrics to support system monitoring and performance analysis activities. Models 370 may be implemented within evaluation system 300 or in a separate computing environment suited for running ML models efficiently, such as an environment that is configured with significant graphics processing unit (GPU) computing power and sufficient video random access memory (VRAM).

In an embodiment, NL-to-SQL model 372 processes NLQ inputs and generates corresponding SQL query statements through trained neural network architectures. NL-to-SQL model 372 analyzes input text to identify query intent, entity references, and relational operations that correspond to database operations, such as selection, filtering, and aggregation. NL-to-SQL model 372 applies learned patterns from training data to map NL constructs to SQL syntax elements, including table names, column references, and conditional expressions. NL-to-SQL model 372 may incorporate database schema information during the conversion process to validate entity references and generate syntactically correct SQL statements that align with target database structures.

In an embodiment, NL-to-SQL model 372 generates confidence scores alongside SQL query outputs that indicate the model's certainty regarding conversion accuracy and semantic correctness. NL-to-SQL model 372 evaluates multiple potential SQL translations for NL inputs and selects the highest-scoring candidate based on learned probability distributions. NL-to-SQL model 372 handles ambiguous NL constructs by generating alternative SQL interpretations and ranking these alternatives according to likelihood scores derived from training data patterns. NL-to-SQL model 372 incorporates contextual information, including previous queries and database state information, to improve conversion accuracy for complex or domain-specific NL inputs.

In an embodiment, NL-to-SQL model 372 adapts to different database dialects and schema configurations through parameterized transformation rules and dialect-specific syntax generation capabilities. NL-to-SQL model 372 processes schema metadata to understand table relationships, column data types, and constraint definitions that influence SQL query structure and syntax requirements. NL-to-SQL model 372 supports incremental learning capabilities that allow NL-to-SQL model 372 to improve performance through exposure to new training examples and feedback from evaluation results. NL-to-SQL model 372 maintains internal state representations that capture learned associations between NL patterns and SQL constructs, supporting consistent translation behavior across similar query types and database configurations.

In an embodiment, SQL-to-NL logic 324 establishes communication channels with SQL-to-NL model 374 located within models 370 to support conversion operations from SQL-to-NL representations. SQL-to-NL logic 324 transmits SQL query strings and associated database schema metadata to SQL-to-NL model 374 through defined interface protocols that handle data serialization and transmission formatting. SQL-to-NL logic 324 preprocesses SQL queries to extract structural elements, including table references, column selections, join conditions, and filtering criteria before sending these parsed components to SQL-to-NL. SQL-to-NL logic 324 manages connection pooling and resource allocation for model communication sessions to optimize throughput and minimize latency during conversion operations.

In an embodiment, SQL-to-NL logic 324 receives NL outputs from SQL-to-NL model 374 and applies post-processing operations to refine the generated text for readability and accuracy. SQL-to-NL logic 324 validates that generated NL statements accurately represent the semantic meaning of the original SQL queries by checking for completeness of translated operations and consistency with database schema constraints. SQL-to-NL logic 324 handles model response formatting, including confidence score extraction, alternative translation retrieval, and error message processing, when model execution encounters problems. SQL-to-NL logic 324 implements retry mechanisms and error recovery procedures to maintain system reliability when model communication failures occur or when model responses include invalid or incomplete NL translations.

In an embodiment, SQL-to-NL logic 324 coordinates conversion request scheduling and manages concurrent processing of multiple SQL-to-NL translation tasks. SQL-to-NL logic 324 queues incoming conversion requests and distributes these requests across available model instances to balance computational load and optimize processing efficiency. SQL-to-NL logic 324 tracks conversion progress and maintains state information for active translation operations to support monitoring and debugging activities. SQL-to-NL logic 324 collects performance metrics, including conversion times, model response quality, and resource utilization statistics, that inform system optimization decisions and support capacity planning for translation workloads.

In an embodiment, SQL-to-NL model 374 analyzes structured SQL query syntax and generates corresponding NL descriptions that capture the semantic intent and operational logic of the original queries. SQL-to-NL model 374 parses SQL statements to identify query components, including table selections, column projections, join operations, filtering conditions, and aggregation functions, before mapping these components to NL equivalents. SQL-to-NL model 374 applies learned linguistic patterns to construct grammatically correct sentences that describe database operations in terms accessible to users without technical SQL knowledge. SQL-to-NL model 374 incorporates database schema information during translation to replace technical identifiers with human-readable entity names and provide context for relational operations between database tables.

In an embodiment, SQL-to-NL model 374 generates confidence assessments that indicate SQL-to-NL model 374's certainty regarding the accuracy and completeness of produced NL translations. SQL-to-NL model 374 evaluates multiple potential NL interpretations for complex SQL queries and selects optimal translations based on learned probability distributions from training data. SQL-to-NL model 374 handles nested queries, subqueries, and complex join operations by decomposing these structures into simpler components and generating hierarchical NL descriptions that preserve the logical flow of the original SQL operations. SQL-to-NL model 374 maintains consistency in terminology and phrasing across related queries to support coherent NL output when processing multiple related SQL statements.

In an embodiment, SQL-to-NL model 374 adapts to different SQL dialects and database-specific syntax variations through configurable translation rules and dialect-aware parsing mechanisms. SQL-to-NL model 374 processes schema metadata to understand entity relationships and data types that influence the appropriate NL terminology for describing database operations. SQL-to-NL model 374 supports customizable output formatting that allows adjustment of NL complexity levels, verbosity settings, and domain-specific terminology preferences based on target audience requirements. SQL-to-NL model 374 incorporates feedback mechanisms that support continuous improvement of translation quality through exposure to corrected examples and evaluation results from scoring module 350.

In an embodiment, schema handler 330 manages the collection and organization of database schema information that supports query conversion and evaluation operations throughout evaluation system 300. Schema handler 330 retrieves schema definitions from multiple sources, including direct database connections, schema files, and metadata repositories, to build comprehensive representations of target database structures. Schema handler 330 processes schema information to extract table definitions, column specifications, data type constraints, and relationship mappings that define the structural characteristics of databases used in evaluation scenarios. Schema handler 330 maintains current versions of schema information and tracks changes to database structures over time to support accurate query conversion operations.

In an embodiment, schema handler 330 validates schema information for completeness and consistency before making the data available to other system components. Schema handler 330 performs integrity checks on schema definitions to identify missing table references, undefined column constraints, and invalid relationship specifications that could impact query conversion accuracy. Schema handler 330 resolves schema dependencies and constructs normalized representations of database structures. Schema handler 330 may generate schema metadata that includes statistical information about table sizes, column distributions, and index configurations to support optimization decisions during query generation and evaluation processes.

In an embodiment, schema handler 330 provides schema information to query generation module 320, NL-to-SQL logic 322, and SQL-to-NL logic 324 through data interfaces that support real-time schema access during conversion operations. Schema handler 330 caches frequently accessed schema information to reduce retrieval latency and improve system responsiveness during high-volume evaluation workflows. Schema handler 330 coordinates with data store 390 to synchronize schema information with stored reference materials and maintains consistency between active schema representations and historical schema versions used in previous evaluations. Schema handler 330 supports schema versioning capabilities that allow evaluation system 300 to work with multiple database configurations simultaneously and track performance differences across schema variations.

In an embodiment, SQL handler 340 manages the processing and manipulation of SQL query statements that flow through evaluation system 300 during conversion and assessment operations. SQL handler 340 receives SQL queries from multiple sources, including query generation module 320, converted outputs from NL-to-SQL logic 322, and reference queries stored in data store 390. Schema handler 330 performs syntactic validation on SQL statements to verify compliance with standard SQL grammar rules and database-specific dialect requirements. SQL handler 340 parses SQL queries to extract structural components, including table references, column selections, join conditions, filtering predicates, and aggregation operations that support subsequent analysis and comparison activities.

In an embodiment, SQL handler 340 normalizes SQL query representations to facilitate accurate comparison between generated queries and reference implementations during evaluation processes. SQL handler 340 applies standardization rules that reorder query clauses, resolve table aliases, and expand abbreviated syntax elements to create consistent query formats. SQL handler 340 handles variations in SQL dialect syntax by translating queries between different database vendor formats while preserving semantic equivalence of the underlying operations. SQL handler 340 maintains parsing state information and error tracking capabilities that support debugging of malformed or invalid SQL statements encountered during evaluation workflows.

In an embodiment, SQL handler 340 coordinates with schema handler 330 to validate that SQL queries reference valid database objects and conform to schema constraints defined in target database configurations. SQL handler 340 checks table names, column references, and data type compatibility between query operations and schema definitions to identify potential execution errors or semantic inconsistencies. SQL handler 340 provides processed SQL query information to analysis module 350 for accuracy assessment and maintains query execution metadata that supports performance analysis of conversion operations. SQL handler 340 tracks SQL query complexity metrics, including join counts, subquery depths, and predicate structures, that inform evaluation scoring algorithms used to assess conversion quality. SQL handler 340 also generates one or more composite complexity metrics that represent one or more other complexity metrics. Complexity metrics and composite complexity metrics are stored in data store 390 as part of evaluation data 396.

In an embodiment, analysis module 350 processes conversion outputs from NL-to-SQL logic 322 and SQL-to-NL logic 324 to perform comprehensive evaluation of query translation accuracy and semantic fidelity. Analysis module 350 receives generated SQL queries and NL descriptions from the conversion logic components and initiates comparison operations against reference implementations stored within the evaluation framework. Analysis module 350 coordinates between validation logic 352 and scoring logic 354 to execute multi-dimensional analysis procedures that assess both semantic correctness and syntactic accuracy of conversion results. Analysis module 350 manages the sequencing of evaluation operations and aggregates results from subordinate logic components to produce comprehensive assessment metrics.

In an embodiment, analysis module 350 maintains reference datasets and gold standard query collections that serve as benchmarks for evaluating conversion quality across different query types and complexity levels. Analysis module 350 processes schema information and contextual metadata to inform comparison operations and supports evaluation scenarios that span multiple database configurations and domain-specific vocabularies. Analysis module 350 generates detailed evaluation reports that quantify conversion performance through statistical measures and provides diagnostic information that identifies specific areas of conversion strength and weakness.

In an embodiment, validation logic 352 performs semantic similarity analysis between generated queries and reference implementations to assess the conceptual accuracy of conversion operations beyond syntactic matching. Validation logic 352 analyzes the semantic structure of SQL queries by parsing query components, including table selections, join conditions, filtering predicates, and aggregation operations, to extract conceptual representations. Validation logic 352 applies NL processing techniques to compare the semantic intent expressed in converted NL descriptions against reference descriptions that capture the expected meaning of corresponding SQL operations. Validation logic 352 generates semantic similarity scores that quantify the degree of conceptual alignment between generated and reference query pairs.

In an embodiment, validation logic 352 implements semantic parsing algorithms that decompose complex queries into constituent semantic elements and evaluates the correctness of individual query components within the broader query context. Validation logic 352 maintains semantic taxonomies and ontological mappings that define relationships between database entities and NL concepts to support accurate semantic comparison operations. Validation logic 352 handles variations in query expression that preserve semantic equivalence while differing in syntactic structure, identifying cases where multiple valid formulations produce identical query results. Validation logic 352 applies semantic reasoning techniques to evaluate the logical consistency of generated queries and identifies semantic errors that could lead to incorrect query execution.

In an embodiment, validation logic 352 coordinates with schema analysis components to incorporate database structure information into semantic validation processes and verify that generated queries reference valid database entities with appropriate semantic relationships. Validation logic 352 maintains semantic validation models that capture domain-specific knowledge and terminology patterns to support accurate evaluation of queries within specialized application contexts. Validation logic 352 generates detailed semantic analysis reports that identify specific semantic discrepancies and provide explanatory information about the nature and severity of detected semantic errors. Validation logic 352 supports incremental learning capabilities that adapt semantic validation criteria based on evaluation feedback and evolving query patterns observed across evaluation datasets.

In an embodiment, scoring logic 354 applies Bidirectional Encoder Representations from Transformers (BERT)-based similarity metrics to quantify the semantic and syntactic correspondence between generated queries and reference implementations through transformer-based language model analysis. Scoring logic 354 processes query pairs through pre-trained BERT models that generate contextual embeddings for both generated and reference queries then calculates similarity scores based on vector distance measures in the embedding space. Scoring logic 354 implements multiple BERT scoring variants, including sentence-level BERT scores that evaluate overall query similarity and token-level BERT scores that assess correspondence at the individual query component level. Scoring logic 354 applies score aggregation algorithms that combine multiple BERT-based metrics to produce composite similarity measures that capture different aspects of query correspondence.

In an embodiment, scoring logic 354 calculates confidence metrics and accuracy measurements by comparing machine-generated SQL queries against reference SQL implementations retrieved from data store 390. Scoring logic 354 receives converted SQL queries from SQL handler 340 and obtains corresponding reference queries from reference SQL queries 392 to perform detailed comparison operations. Scoring logic 354 applies multiple scoring algorithms that evaluate syntactic similarity, semantic equivalence, and structural correspondence between generated and reference query pairs. Scoring logic 354 processes schema information from schema handler 330 to understand database context and validate that query comparisons account for valid alternative formulations that produce equivalent results.

In an embodiment, scoring logic 354 generates numerical confidence scores that quantify the accuracy of query conversions performed by NL-to-SQL logic 322 and SQL-to-NL logic 324 through weighted combinations of syntactic matching scores, semantic similarity measures, and execution equivalence assessments. Scoring logic 354 calculates confidence values based on statistical analysis techniques that aggregate scores across multiple test cases and generate performance distributions characterizing model behavior under different query complexity conditions. Scoring logic 354 maintains scoring history and tracks performance trends over time to support longitudinal analysis of model improvement and degradation patterns. Scoring logic 354 implements additional scoring algorithms that complement BERT-based analysis, including syntactic similarity measures, structural alignment scores, and execution equivalence assessments.

In an embodiment, scoring logic 354 coordinates with orchestration module 360 to deliver completed evaluation results. Scoring logic 354 processes batch scoring requests for large test datasets and manages resource allocation to optimize scoring throughput while maintaining accuracy of comparison operations. Scoring logic 354 generates detailed scoring reports that include individual query scores, accuracy scores, aggregate performance metrics, and statistical summaries that support analysis of conversion system performance. Scoring logic 354 provides scoring results to input/output module 310 for external delivery and maintains internal performance databases that support system monitoring and optimization activities within evaluation system 300.

In an embodiment, scoring logic 354 maintains scoring thresholds and calibration parameters that define quality benchmarks for different types of queries and conversion scenarios. Scoring logic 354 coordinates with validation logic 352 to incorporate semantic validation results into comprehensive scoring calculations and generates unified evaluation metrics that combine semantic accuracy assessments with similarity-based scoring measures. Scoring logic 354 provides detailed scoring breakdowns that identify specific query components or conversion aspects that contribute to overall quality scores and generates diagnostic information that supports system optimization and debugging activities.

In an embodiment, scoring logic 354 supports configurable scoring parameters and human intervention points that allow adjustment of scoring criteria and weighting factors based on evaluation requirements and domain-specific quality standards. Scoring logic 354 maintains scoring history and performance tracking capabilities that support longitudinal analysis of conversion system improvement over time and across different evaluation scenarios. Scoring logic 354 calculates weighted combinations of different scoring methods to generate comprehensive evaluation metrics that reflect multiple dimensions of query quality and accuracy. Scoring logic 354 applies statistical analysis techniques to aggregate scores across multiple test cases and generate performance distributions that characterize model behavior under different query complexity conditions.

In an embodiment, orchestration module 360 coordinates the execution sequence and timing of operations across the components within evaluation system 300 to manage evaluation workflows from initiation to completion. Orchestration module 360 receives evaluation requests from input/output module 310 and determines the appropriate processing path based on the type of conversion used and the available system resources. Orchestration module 360 schedules tasks across query generation module 320, schema handler 330, SQL handler 340, and analysis module 350 while monitoring processing progress and managing dependencies between sequential operations. Orchestration module 360 maintains workflow state information and tracks the completion status of individual evaluation tasks to support coordination of complex multi-step evaluation processes.

In an embodiment, orchestration module 360 manages resource allocation and load balancing across system components to optimize processing efficiency and prevent resource contention during concurrent evaluation operations. Orchestration module 360 monitors system capacity and distributes evaluation workloads based on current component utilization levels and expected processing times for different types of conversion tasks. Orchestration module 360 implements priority queuing mechanisms that allow urgent evaluation requests to bypass standard processing queues while maintaining fairness for routine evaluation operations. Orchestration module 360 coordinates with models 370 to manage model access requests and schedules model interactions to minimize conflicts between competing conversion operations.

In an embodiment, orchestration module 360 handles error recovery and exception management across the evaluation workflow to maintain system reliability when individual components encounter processing failures. Orchestration module 360 implements retry logic and fallback procedures that attempt alternative processing paths when primary components become unavailable or generate invalid results. Orchestration module 360 collects error information and diagnostic data from system components to support troubleshooting activities and system maintenance operations. Orchestration module 360 provides workflow status updates to input/output module 310 and maintains audit logs that track evaluation request processing times, resource utilization patterns, and system performance metrics that inform capacity planning and optimization decisions.

FIG. 3 also illustrates SQL Database 380. In an embodiment, SQL Database 380 functions as an external database system that provides execution environments for validating generated SQL queries and verifying conversion accuracy during evaluation processes. SQL Database 380 receives SQL query statements from SQL handler 340 and executes these queries against configured database schemas to produce result sets that support semantic equivalence testing. SQL Database 380 maintains multiple schema configurations that correspond to different evaluation scenarios and supports concurrent query execution across isolated database instances. SQL Database 380 implements standard SQL compliance features and supports multiple database dialects to accommodate queries generated for different target database platforms.

In an embodiment, SQL Database 380 interacts with schema handler 330 to share current database structure definitions that align with schema information used throughout evaluation system 300. SQL Database 380 processes schema updates and structural modifications that reflect changes in target database configurations during evaluation workflows. SQL Database 380 provides query execution statistics, including execution times, resource utilization metrics, and result set characteristics, that inform performance analysis of generated queries SQL Database 380 handles error conditions that arise from malformed or semantically invalid SQL queries and returns diagnostic information that supports debugging of conversion operations.

Data store 390 is also illustrated in FIG. 3. In one or more embodiments, data store 390 is any type of storage unit and/or device (e.g., a file system, database, collection of tables, or any other storage mechanism) for storing data. Furthermore, data store 390 may include multiple different storage units and/or devices. The multiple different storage units and/or devices may or may not be of the same type or located at the same physical site. Furthermore, data store 390 may be implemented or executed on the same computing system as evaluation system 300. Additionally, or alternatively, a data store 390 may be implemented or executed on a computing system separate from evaluation system 300. Data store 390 may be communicatively coupled to evaluation system 300 via a direct connection or via a network.

In an embodiment, data store 390 maintains reference materials and supporting data structures used for evaluation operations within evaluation system 300. Data store 390 organizes stored information into specialized collections that include reference SQL queries 392, schema information 394, and query-to-schema maps 398 to support different aspects of the evaluation workflow. The data store implements indexing and retrieval mechanisms that provide efficient access to stored data based on query characteristics, schema identifiers, and evaluation criteria. Data store 390 maintains data integrity through backup procedures and consistency checks that verify the completeness and accuracy of stored reference materials over time.

In an embodiment, data store 390 provides version control capabilities that track changes to reference materials and support rollback operations when data updates introduce inconsistencies or errors. The data store maintains metadata records that describe the characteristics of stored reference queries and schema definitions to support evaluation result interpretation. Data store 390 implements security controls that restrict access to sensitive reference materials based on authentication credentials and usage permissions defined within evaluation system 300. The data store generates usage statistics and access logs that support system monitoring and performance analysis activities while providing audit trails for reference data modifications and evaluation result generation.

In an embodiment, reference SQL queries 392 represents a data collection within data store 390 that includes SQL statements serving as ground truth examples for evaluating machine-generated query conversions. Reference SQL queries 392 includes SQL statements. The SQL statements may be paired with corresponding NL descriptions and expected result sets to support comprehensive accuracy assessment. Reference SQL queries 392 encompasses queries of varying complexity levels from simple selection operations to complex multi-table joins with subqueries and aggregation functions, reaching up to hundreds of lines or more. Reference SQL queries 392 maintains query metadata, including creation timestamps, validation status, and target database compatibility information, that supports selective retrieval during evaluation processes.

In an embodiment, reference SQL queries 392 organizes stored queries according to categorical classifications, including query type, complexity metrics, and database dialect specifications, to facilitate efficient access by analysis module 350. Reference SQL queries 392 provides structured storage that maintains referential links between SQL statements and their associated NL equivalents to support bidirectional conversion evaluation. Reference SQL queries 392 includes execution metadata that describes expected query behavior, typical result set characteristics, and performance benchmarks derived from previous execution against target database systems. Reference SQL queries 392 supports query versioning that tracks modifications to stored SQL statements and maintains historical records of query evolution over time.

In an embodiment, reference SQL queries 392 supports automated quality assurance procedures that identify obsolete or invalid queries and flag potential inconsistencies that could impact evaluation accuracy. Reference SQL queries 392 provides statistical summaries that describe the distribution of query types, complexity patterns, and coverage characteristics across different database domains and application scenarios. Reference SQL queries 392 maintains access logs that track query retrieval patterns and usage frequencies to support optimization of storage organization and retrieval performance within data store 390.

In an embodiment, schema information 394 represents a data collection within data store 390 that maintains comprehensive database structure definitions and other schema elements, including table layouts, column specifications, data types, and relational constraints, for evaluation target databases. Schema information 394 stores normalized schema representations that eliminate structural redundancies and resolve naming conflicts between different database versions or vendor implementations. Schema information 394 includes constraint definitions, index specifications, and foreign key relationships that define data integrity rules and structural characteristics of target database systems. Schema information 394 maintains schema versioning information that tracks structural changes over time and supports evaluation of queries against different database configuration states.

In an embodiment, schema information 394 provides structured storage for database metadata that describes table characteristics, column properties, and relational dependencies used by schema handler 330 during query validation and conversion operations. Schema information 394 includes statistical information about database characteristics, such as table sizes, column cardinalities, and data distribution patterns, that inform query optimization decisions. Schema information 394 maintains compatibility matrices that specify relationships between different schema versions and identify structural dependencies that impact query portability across database configurations. Schema information 394 supports schema comparison operations that detect structural differences and assess the impact of database changes on stored query validity.

In an embodiment, schema information 394 provides schema validation services that verify structural completeness and identify missing or inconsistent schema elements that could impact evaluation reliability. Schema information 394 generates schema documentation that describes database structure characteristics and supports analysis of evaluation results across different database configurations and platforms.

In an embodiment, evaluation data 396 represents a data collection within data store 390 that stores scoring results, performance metrics, and assessment outcomes generated during query conversion evaluation processes that serve as training data for ML model improvement. Evaluation data 396 maintains detailed records of confidence scores, accuracy measurements, and comparative analysis results produced by scoring logic 354 and validation logic 352 for individual query conversion operations alongside feedback labels that indicate conversion quality. Evaluation data 396 organizes evaluation results according to query types, conversion directions, model versions, and evaluation timestamps to support comprehensive performance tracking and ML training dataset preparation. Evaluation data 396 includes statistical summaries, performance distributions, and trend analyses that characterize conversion system behavior and provide labeled examples for supervised learning algorithms.

In an embodiment, evaluation data 396 stores longitudinal performance data that tracks model improvement and degradation patterns over multiple evaluation cycles and training iterations while accumulating training examples that demonstrate successful and unsuccessful conversion patterns. Evaluation data 396 maintains historical records of scoring thresholds, calibration parameters, and quality benchmarks that support comparative analysis of system performance and provide reference standards for training ML models to recognize quality indicators. Evaluation data 396 provides aggregated performance metrics that summarize conversion accuracy and generate training labels for models that learn to assess query conversion quality automatically.

In an embodiment, evaluation data 396 is used by models 370 to supply labeled training datasets for ML algorithms that learn to predict conversion quality, estimate confidence scores, and identify potential conversion errors based on query characteristics and evaluation outcomes. Evaluation data 396 maintains training data partitions that separate evaluation results into development, validation, and test sets to support proper ML model training and evaluation procedures.

In an embodiment, query-to-schema maps 398 represents a data collection within data store 390 that stores SQL-to-NL and NL-to-SQL paired data with corresponding schema mappings to support ML training operations. Query-to-schema maps 398 maintains bidirectional query associations that link SQL statements with their NL equivalents alongside schema context information that defines the database structures referenced by query pairs. Query-to-schema maps 398 organizes training examples according to query complexity levels, schema types, and conversion directions to support targeted model training scenarios. Query-to-schema maps 398 includes metadata annotations that describe query characteristics, conversion difficulty levels, and domain-specific terminology patterns that inform ML algorithm selection and parameter tuning.

In an embodiment, query-to-schema maps 398 provides structured training datasets that ML models access during training phases to learn patterns and associations between natural language expressions and corresponding SQL query structures. Query-to-schema maps 398 maintains quality indicators and validation flags that identify high-confidence training examples and identify potentially problematic query pairs that could introduce noise into model training processes. Query-to-schema maps 398 supports data augmentation capabilities that generate additional training examples through systematic variations of existing query pairs while preserving semantic equivalence and schema consistency. In an embodiment, query-to-schema maps 398 is used by models 370 to supply training data for NL-to-SQL model 372 and SQL-to-NL model 374 during model development and refinement cycles.

Additional embodiments and/or examples relating to computer networks are described below in Section 7, titled “Computer Networks and Cloud Networks.” Information may be implemented across any of components within evaluation system 300. However, this information is illustrated within the data store 390 for purposes of clarity and explanation.

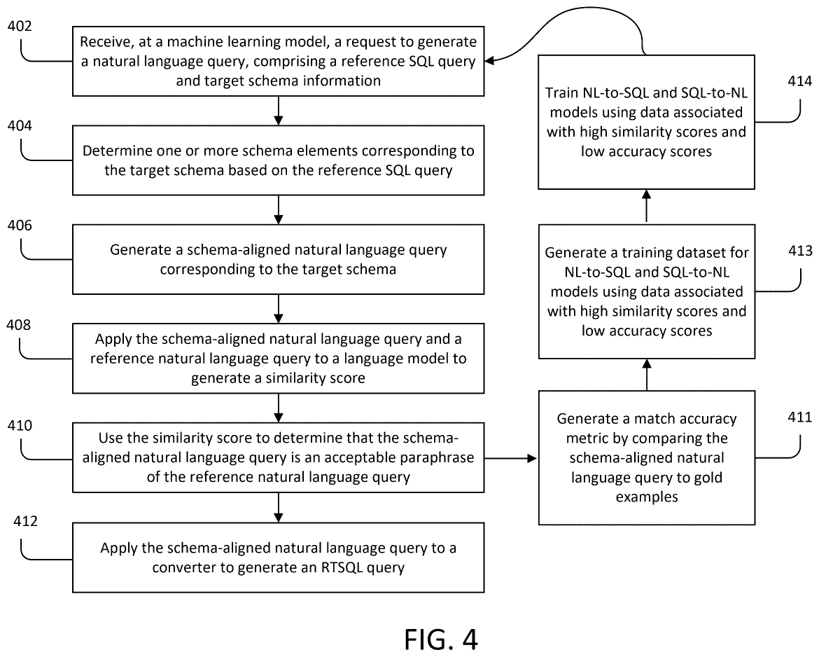

In one or more embodiments, evaluation system 300 refers to hardware and/or software configured to perform operations described herein for evaluation system 300. Examples of operations for evaluation system 300 are described below with reference to FIG. 4.

In an embodiment, evaluation system 300 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. Evaluating and Improving NL-to-SQL Models

FIG. 4 illustrates an example set of operations for evaluating and improving NL-to-SQL models in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, the system receives, at an ML model, a request comprising a reference SQL query and target schema information to generate an NLQ (Operation 402). The request is received as input to the ML model and may be in the form of a query string, API call, or other data transmission. The reference SQL query and target schema information are provided as part of the request and may be used by the ML model to generate an NLQ that accurately reflects the intent and semantics of the SQL query. The system processes the request to extract the reference SQL query and target schema information that are then used as inputs to the ML model. The system may receive requests from various sources, such as user interfaces, applications, or other systems.

In an embodiment, the system determines one or more schema elements corresponding to the target schema based at least in part on the reference SQL query (Operation 404). The system analyzes the reference SQL query to identify relevant schema elements, such as tables, columns, and relationships, that are used in the query. The system may parse the SQL query to extract keywords, identifiers, and other syntax elements that provide clues about the schema elements. The determined schema elements may include information about data types, data formats, and relationships between data fields that are used to inform the generation of an NLQ. The system uses this information to create a schema representation that is relevant to the reference SQL query.

In an embodiment, the system generates a schema-aligned NLQ corresponding to the target schema (Operation 406). The schema-aligned NLQ includes one or more NLQ elements that correspond to schema elements of the one or more schema elements. The NLQ elements may be phrases, words, or other linguistic constructs that reflect the structure and semantics of the schema elements. The system uses an ML model or other NL generation techniques to generate the schema-aligned NLQ. The generated NLQ is aligned with the target schema, meaning that it accurately reflects the schema elements and their relationships. The schema-aligned NLQ may be used as input to further processing, such as evaluation, refinement, or transformation into another query format.

In an embodiment, generating the schema-aligned NLQ comprises identifying data fields relevant to the reference SQL query. The system analyzes the reference SQL query to determine the data fields that are used and how they are related. The identified data fields are added into the schema-aligned NLQ. The system uses this information to generate an NLQ that accurately reflects the intent and semantics of the reference SQL query. The NLQ includes one or more identified data fields and accurately reflects the schema elements and their relationships.

In an embodiment, identifying data fields relevant to the reference SQL query comprises identifying one or more data fields that serve as key fields using the one or more schema elements. These key fields correspond to primary keys or foreign keys associated with one or more database tables referenced in the reference SQL query. The system analyzes the schema elements to determine the data fields that play a key role in the query and identifies the corresponding primary or foreign keys. The identified key fields are used to generate an NLQ that accurately reflects the relationships between the data fields. The system may use this information to emphasize or highlight important data fields in the NLQ. The identified key fields help to provide context and meaning to the NLQ.

In an embodiment, the system applies the schema-aligned NLQ and a reference NLQ to a language model to generate a similarity score (Operation 408). The language model analyzes the two queries and computes a score that indicates the level of semantic overlap between them. The similarity score may be based on various factors, such as the presence of common entities, relationships, or concepts in both queries. The system uses the similarity score to evaluate the accuracy and effectiveness of the schema-aligned NLQ generation process. The reference NLQ serves as a “gold standard” for evaluating the quality of the generated schema-aligned NLQ. The similarity score provides a quantitative measure of the similarity between the two queries, allowing the system to assess the performance of the NL generation process.

In an embodiment, the system uses the similarity score to determine that the schema-aligned NLQ is an acceptable paraphrase of the reference NLQ (Operation 410). The system compares the similarity score to a predetermined threshold value, and if the score meets or exceeds the threshold, the system considers the schema-aligned NLQ to be an acceptable paraphrase. The threshold value may be adjusted based on the specific expectations of the application or use case. If the schema-aligned NLQ is deemed an acceptable paraphrase, the system may use it for further processing, such as training or evaluation. The determination that the schema-aligned NLQ is an acceptable paraphrase indicates that the NL generation process has produced a query that accurately captures the intent and semantics of the reference NLQ. The system may also use this determination to validate the performance of the NL generation process.

In an embodiment, the system determines, using the similarity score, that the schema-aligned NLQ is not an acceptable paraphrase of the reference NLQ. In response, the system modifies the ML model through training. The system uses the schema-aligned NLQ, the gold SQL query, and the reference NLQ as training data, labeling the schema-aligned natural language query as an unacceptable match. This creates a modified ML model that may be used to generate post-modification schema-aligned NLQs corresponding to the target schema.

In some embodiments, the system may incorporate one or more ML models to perform various processing tasks. For example, distinct models may be employed for different tasks, such as text classification, NL parsing, structured query generation, or data retrieval. Alternatively, a single unified model may be used to perform multiple tasks within the system. In certain implementations, a base language model may be augmented with one or more low-rank adaptation (LoRA) modules configured for specific subtasks. For instance, a LoRA module may be trained for and selectively applied during NL-to-SQL conversion, thereby enabling task-specific adaptation while preserving the underlying model weights. The system may dynamically select whether to invoke a specialized LoRA or operate the base model without adaptation, depending on task requirements, input characteristics, or system resource constraints.

In an embodiment, the system generates a match accuracy metric by comparing the schema-aligned NLQ to “gold” examples (Operation 411). The “gold” examples are NLQs that are known to be associated with the SQL used to generate the schema-aligned NLQ.

In an embodiment, the system applies the schema-aligned NLQ to a converter to generate an SQL query (Operation 412). The resulting SQL query is referred to herein as a “round-trip SQL (RTSQL) query,” which is distinct from a conventional SQL query in that it has undergone a transformation process that provides a basis for evaluating its semantic consistency and robustness. Unlike a conventional SQL query, which may be crafted directly by a user or application, an RTSQL query has been generated through a round-trip process of conversion to NL and back to SQL using a schema-aligned NLQ as an intermediate representation. This process can introduce subtle differences in the query's syntax, semantics, or optimization characteristics, making an RTSQL query potentially more resilient to errors, ambiguities, or changes in the underlying schema. As a result, RTSQL queries may exhibit unique properties or advantages that distinguish them from conventional SQL queries, such as improved query robustness, enhanced semantic clarity, or increased resistance to adversarial attacks.

In an embodiment, the system compares the RTSQL query with the original “gold” query to identify or rule out the possibility of linking errors. A linking error, in the context of NLP and semantic parsing, refers to an error that occurs when mapping or “linking” an NLQ to a specific database schema or knowledge graph. A linking error can happen when the model incorrectly identifies the relevant entities, relationships, or tables in the schema, leading to an incorrect or incomplete semantic representation of the query. In other words, a linking error occurs when the model fails to accurately connect the NLQ to the correct database schema elements, such as tables, columns, or relationships. This can result in incorrect or ambiguous SQL queries being generated from NL queries. Linking errors can be particularly difficult to identify.

By using the RTSQL query generation process, the system mitigates the possibility of linking errors, for the RTSQL query is generated from a schema-aligned NLQ that has already been semantically “linked” to the schema. Therefore, if there are still errors in the RTSQL query, they are likely due to errors in the NL-to-SQL model itself rather than linking errors. If the system determines that the RTSQL query substantially matches the reference SQL query, the system may execute an error clearance process. For example, an error clearance process may include clearing or resolving any errors indicating a possible linking error. The clearance process may also trigger a re-evaluation of potential errors with the NL-to-SQL model. The clearance process may also include logging the absence of linking errors, such as syntax errors, semantic errors, or structural errors, that were previously suspected. The system can also update its internal state to reflect the successful match between the RTSQL query and the reference SQL query, allowing it to learn from the experience and improve its future performance. By clearing errors and resolving discrepancies, the system can ensure that its query generation capabilities are not likely to be hindered by linking errors. The error clearance process can also involve notifying other components or modules of the system that the error has been cleared, allowing them to adjust their behavior accordingly.

In an embodiment, if the system finds discrepancies between the RTSQL query and the original query, the system investigates further to determine the cause of the errors. The system analyzes the differences between the two queries to identify potential issues in the NL-to-SQL model. For example, if the RTSQL query uses a different table or column name than the original query, the system identifies this as a potential issue with the model's ability to accurately map NLQs to schema elements. Alternatively, if the RTSQL query has a different query structure or join order than the original query, the system recognizes this as a potential issue with the model's ability to generate optimal or semantically equivalent queries. The system may then use this information to refine the NL-to-SQL model, such as by retraining the model on additional data or adjusting its parameters.

In an embodiment, the system responds to identified linking errors by revising the NL-to-SQL model to improve its accuracy. The system updates the model to better handle specific types of queries or schema elements that were associated with the linking errors. The system may also use this information to improve the schema-aligned NLQ generation process, helping to reduce the occurrence of linking errors in the future.

In an embodiment, the system responds to a determination that errors are due to the NL-to-SQL model by refining the model to improve its performance. The system updates the model to better handle specific types of queries or schema elements that were associated with the errors. The system may retrain the model on additional data, adjust its parameters, or use other techniques to improve the model's accuracy.

In an embodiment, in response to determining that the RTSQL query substantially matches the reference SQL query, the system adds the schema-aligned NLQ to an evaluation dataset. The system creates a dataset of high-quality, semantically valid, schema-aligned NLQs that can be used to evaluate the performance of future NL-to-SQL models or to fine-tune existing models. The evaluation dataset comprises pairs of schema-aligned NLQs and corresponding SQL queries that have been validated through the round-trip process.

In an embodiment, the system generates a training dataset for NL-to-SQL and SQL-to-NL models using data associated with high similarity scores and low accuracy scores (Operation 413). Training data is not limited to data associated with high similarity scores and low accuracy scores. The system may also incorporate additional data into the training dataset, such as data associated with high accuracy scores, to provide a diverse training set. The training dataset comprises a combination of data from various sources, including data pairs with high similarity scores and low accuracy scores, as well as other relevant data. The system uses this training dataset to train and fine-tune the NL-to-SQL and SQL-to-NL models, helping to improve their performance and accuracy.

In an embodiment, the system selects a first set of SQL queries and a first set of corresponding target schemas. The system chooses these queries and schemas to provide a representative sample of the types of queries and schemas that the NL-to-SQL model or SQL-to-NL model will encounter. The selected SQL queries may vary in complexity, syntax, and semantics. The corresponding target schemas may also vary in structure, size, and complexity. The system uses these queries and schemas to generate a dataset that can be used to train and evaluate the NL-to-SQL model and the SQL-to-NL model.

In an embodiment, the system applies SQL queries and corresponding schemas to the NL-to-SQL model. The system uses this process to generate a first set of schema-aligned NLQs. The generated NLQs capture the semantic meaning and intent of the original SQL queries. The system stores these NLQs for further processing and analysis. The generated NLQs capture the semantic meaning and intent of the original SQL queries. The system stores these NLQs for further processing and analysis. More than one NLQ can be generated for any given SQL query. The NL-to-SQL model transforms the NLQs into NLQs that are aligned with the corresponding schemas. More than one SQL query can be generated for any given NLQ.

In an embodiment, the system stores a mapping that includes a plurality of mapping entries. Mapping entries comprise a subject schema-aligned NLQ from the first set of schema-aligned NLQs and a corresponding SQL query from the first set of SQL queries. The mapping may also include a complexity metric for mapping entries. The complexity metric may be based on the number of joins in the SQL query or on some other complexity-related attribute of the SQL query corresponding to the mapping entry. The system uses this mapping to support the evaluation and refinement of the NL-to-SQL model. The mapping entries provide a valuable resource for analyzing the performance of the model.

In an embodiment, the system trains NL-to-SQL and SQL-to-NL models using data associated with high similarity scores and low accuracy scores (Operation 414). By focusing on data pairs with high similarity scores and low accuracy scores, the system improves the performance of the NL-to-SQL and SQL-to-NL models on challenging queries. The system reduces the impact of noisy or ambiguous data by selectively weighting or sampling the data pairs based on their similarity scores and accuracy scores. This approach enables the system to optimize the models for queries that are likely to be ambiguous or difficult to translate.

In an embodiment, the system utilizes a unified model configuration, wherein the model that generates NLQs from SQL queries, the model that generates similarity scores between NLQs and SQL queries, and the model that generates SQL queries from NLQs are all the same model. This configuration can be particularly useful in scenarios where computational resources are limited, and a single model can efficiently handle multiple tasks. For example, in a real-time query translation application, a single model can be trained to generate NLQs from SQL queries, generate similarity scores to validate the accuracy of the translations, and generate SQL queries from NLQs to facilitate query execution. By leveraging a unified model configuration, the system can reduce its computational footprint, simplify its architecture, and improve its overall efficiency. In this configuration, the model can be trained on a multi-task learning objective, where it learns to perform all three tasks simultaneously, sharing knowledge and representations across tasks. This can lead to improved performance on each individual task, as well as enhanced overall system efficiency.

The system filters the training dataset to include data with high similarity scores and low accuracy scores. The system uses various dynamic thresholds and criteria to determine if data pairs meet the selection criteria, such as a minimum similarity score or a maximum accuracy score. By selectively training on these data pairs, the system enhances the robustness and accuracy of the NL-to-SQL and SQL-to-NL models.

In an embodiment, the system evaluates the effectiveness of the data selection approach by monitoring the performance of the NL-to-SQL and SQL-to-NL models on a validation set. The system adjusts the data selection criteria and thresholds as needed to optimize model performance. This iterative process enables the system to refine the models and improve their accuracy over time.

In an embodiment, the system uses active learning techniques to selectively query a human annotator or expert to provide additional labels or corrections for the data pairs with high similarity scores and low accuracy scores. The system incorporates this additional feedback into the training dataset to further improve the performance of the NL-to-SQL and SQL-to-NL models. This approach enables the system to adapt to changing data distributions and user needs over time.

In an embodiment, the training dataset may be used to train a model configured to generate NLQs from SQL queries as well as train a model configured to configured to generate SQL queries from NLQs. The NL-to-SQL and SQL-to-NL models may be the same model, or the NL-to-SQL and SQL-to-NL models may be separate models. If the models are separate or if a LoRA is being trained for both cases (NL-to-SQL and SQL-to-NL), then the data may be used differently. For example, the system uses the training dataset to train a model configured to generate NLQs from SQL queries as well as train a model configured to generate SQL queries from NLQs. The system may use the same model for both NL-to-SQL and SQL-to-NL tasks, or the system may use separate models for different tasks. If the system uses separate models or trains a LoRA for both cases (NL-to-SQL and SQL-to-NL), then the system processes the data differently.

In an embodiment, the system constructs the training dataset to comprise a large corpus of paired SQL and NLQs used to train a pre-trained language model or trains a new model from scratch. The system sources the data from various applications, such as existing query logs, user-generated content, or synthetic data generated through automated processes. The system optimizes the quality and diversity of the training dataset to improve the performance of the NL-to-SQL and SQL-to-NL models.

In an embodiment, the system implements the NL-to-SQL model to accept an NLQ as input and generate a corresponding SQL query as output. The system uses various techniques, such as sequence-to-sequence learning, attention mechanisms, or graph-based methods, to map the NLQ to an SQL query. Similarly, the system implements the SQL-to-NL model to take an SQL query as input and generate a corresponding NLQ as output. The system evaluates the models using various metrics, such as accuracy, precision, recall, or F1-score, to measure their performance.

In an embodiment, the system benefits from using a shared model for both NL-to-SQL and SQL-to-NL tasks in terms of computational efficiency and model simplicity. However, the system may achieve more specialized and optimized performance by using separate models for the tasks. The system selects the model architecture and training approach based on the specific expectations and constraints of the application, such as the need for low latency, high accuracy, or scalability.

In an embodiment, the system uses a LoRA approach to adapt a pre-trained model to the specific tasks of NL-to-SQL and SQL-to-NL. The system adds a small number of learnable parameters to the pre-trained model that are trained on the specific task data. This approach enables the system to reduce the computational resources required for training and improve the efficiency of the model.

In an embodiment, the system modifies a model by adjusting its parameters or hyperparameters. This modification can be done instead of, or in addition to, training the model. By changing the parameters or hyperparameters, the system alters the behavior of the model, resulting in a distinct model that produces different outputs. The modified model can exhibit improved performance, changed biases, or altered strengths and weaknesses. The system may modify the model in response to evaluation metrics, such as accuracy or F1 score, that indicate a need for improvement.

In an embodiment, the system updates model documentation and records to reflect the changes made to the model. The system also updates any dependent systems or components that rely on the model to ensure that they are compatible with the modified model. Furthermore, the system may re-run evaluation tests and validation protocols to ensure that the modified model meets the desired performance standards. The system may also use the modified model as a starting point for further refinement and improvement. Additionally, the system may track the changes made to the model to maintain a record of model evolution and updates. The system uses this information to support model maintenance, debugging, and future development.

In an embodiment, based on a mapping between the reference SQL query and the schema-aligned NLQ, the system modifies an SQL query generation process that generates SQL queries to be executed on a database associated with the target schema. The system uses this mapping to refine the SQL query generation process, ensuring that the generated SQL queries accurately reflect the intent and semantics of the NLQs. The modified SQL query generation process may produce more efficient, accurate, or optimized SQL queries.

In an embodiment, the system updates the SQL query generation process by incorporating the learned mappings and relationships between NLQs and SQL queries. The system may use this updated process to generate SQL queries for a variety of applications, such as query recommendation systems, data exploration tools, or NL interfaces to databases. The modified SQL query generation process may support improved query accuracy, reduced errors, or enhanced user experience. The system may continue to refine and update the SQL query generation process over time as it learns from additional data and user interactions. The system uses the modified SQL query generation process to support a range of use cases and applications.

In an embodiment, the system incorporates learned mappings into query templates by analyzing the correlations between natural language queries (NLQs) and their corresponding SQL queries. This process begins with extracting key phrases and semantic elements from the NLQs and mapping them to specific SQL query structures. The system then updates its query templates to include placeholders for these elements, allowing for more flexible and accurate SQL query generation. For example, if the mapping indicates that NLQs containing the phrase “top-rated” often correspond to SQL queries with a “ORDER BY” clause and a “LIMIT” clause, the system can modify its templates to include these clauses when generating SQL queries for similar NLQs. By incorporating learned mappings into query templates, the system can improve the accuracy and relevance of generated SQL queries, reducing the need for post-processing corrections. Furthermore, the system can continuously refine its templates based on new mapping data, ensuring that its SQL query generation capabilities remain up-to-date and effective.

In an embodiment, the system updates model parameters by leveraging the mapping between reference SQL queries and schema-aligned NLQs to fine-tune its SQL query generation model. This process involves backpropagating errors and adjusting the model's weights to minimize the difference between generated SQL queries and reference SQL queries. The system can use various optimization algorithms, such as stochastic gradient descent (SGD) or Adam, to update the model's parameters based on the mapping data. By iteratively refining its parameters, the system can improve its ability to accurately translate NLQs into SQL queries, capturing the nuances of language and schema semantics. Additionally, the system can use techniques such as regularization and early stopping to prevent overfitting and ensure that the updated model generalizes well to new, unseen data. As a result, the system's SQL query generation capabilities become more robust and accurate, enabling it to effectively handle a wide range of NLQs and schema configurations.

In an embodiment, the system improves query optimization by utilizing the mapping to identify opportunities for optimization. By analyzing the relationships between NLQs and their corresponding SQL queries, the system can determine which optimization techniques are most effective for specific query patterns. For instance, if the mapping indicates that NLQs containing certain keywords often result in SQL queries with expensive join operations, the system can apply optimization techniques such as indexing or caching to reduce query execution times. The system can also use the mapping to identify opportunities for rewriting queries, such as converting correlated subqueries to joins or applying window functions. By incorporating these optimizations into its query generation process, the system can produce SQL queries that are not only accurate but also efficient and scalable. Furthermore, the system can continuously refine its optimization strategies based on new mapping data, ensuring that its query optimization capabilities remain effective and up-to-date.

In an embodiment, the system develops dynamic query generation rules by analyzing the mapping between reference SQL queries and schema-aligned NLQs. This process involves extracting key insights and patterns from the mapping data, such as the relationships between linguistic constructs in NLQs and SQL query structures. The system then uses these insights to create dynamic rules that dictate how to handle specific query scenarios, such as handling ambiguity, resolving references, or optimizing query performance. For example, if the mapping indicates that NLQs containing certain phrases often require specific SQL query structures, the system can create rules that enforce these structures when generating SQL queries. By dynamically updating its rules based on new mapping data, the system can adapt to changing requirements and improve its SQL query generation capabilities over time. Additionally, the system can use machine learning techniques to refine its rules and ensure that they are effective and efficient.

### 6. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

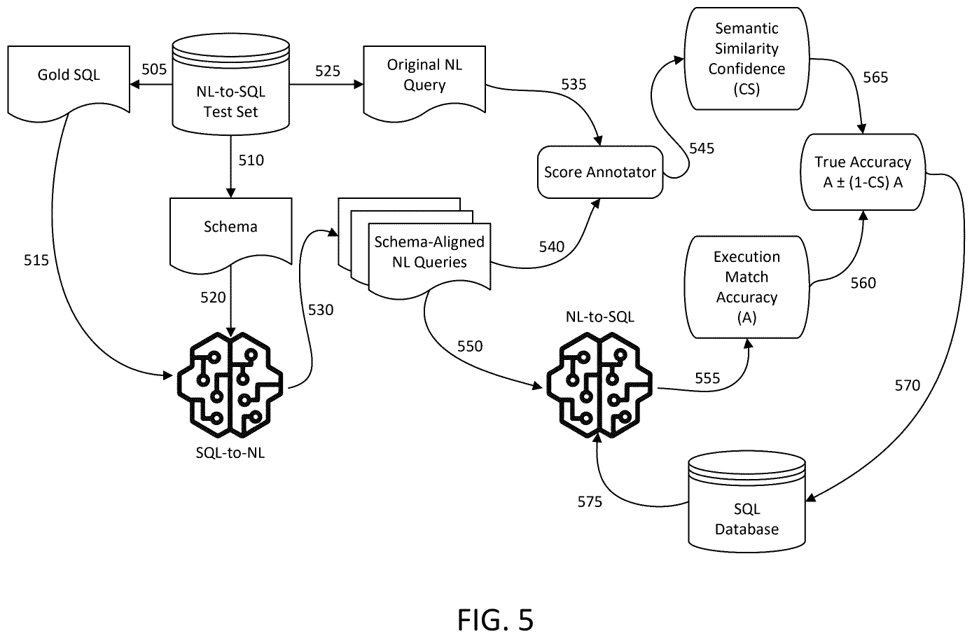

FIG. 5 illustrates an example set of operations for evaluating and improving NL-to SQL models in accordance with one or more embodiments. FIG. 5 may be modified, rearranged, or omitted. Accordingly, the particular sequence of operations illustrated in FIG. 5 should not be construed as limiting the scope of one or more embodiments.

In an embodiment, the system obtains gold SQL from an NL-to-SQL test set (Operation 505) and obtains schema information from an NL-to-SQL test set (Operation 510). By grounding on the schema, an SQL-to-NL model generates k schema-aligned NL queries that introduce linguistic variation while preserving semantic equivalence. While SQL-to-NL and NL-to-SQL could be handled by separate models, here we use a single unified model for both. The NL-to-SQL model is evaluated on schema-aligned queries, measuring performance degradation against the original. Model-based evaluators/annotators or human evaluators assess semantic similarity, generating confidence scores (CS) to adjust accuracy for robust evaluation.

In an embodiment, the system provides the gold SQL and schema information to a SQL-to-NL model (Operations 515 and 520). The SQL queries are combined with schema definitions, followed by specific instructions to enforce diversity constraints. A prompt accompanies the submission of a query/schema combination. An example prompt follows:

Given the following database schema and an SQL query, generate {num queries} distinct natural language questions that describe the purpose and output of the SQL query.
{schema_definitions}

### SQL Query:

{sql_query}

### Instructions:

1. Generate {num_queries} natural language questions that reflect the intent of the SQL query.
2. Each question should vary in phrasing, structure, and wording, but all questions must remain logically equivalent.
3. Do not include explanations, task descriptions, or any additional comments in the output.

### Output Format:

1. <First question>
2. <Second question>
   . . .
   {num_queries}. <Nth question>.

In an embodiment, the system obtains the original NL query associated with the gold SQL from the NL-to-SQL test set (Operation 525). For example, the original NL query associated with the gold SQL from the NL-to-SQL test set may be “Find the name of the makers that produced some cars in the year of 1970?”

In an embodiment, the system generates a set of schema-aligned NL queries (Operation 530). Conditioning the queries on both the SQL and the schema information ensures that paraphrased NL queries that are schema-aligned are semantically equivalent to the gold SQL and explicitly grounded in the schema, thereby reducing schema mismatches. Paraphrased queries conditioned on SQL and schema minimize schema linking errors relative to the original queries. Intuitively, this assertion depends heavily on the nature of the original queries, for the structure, phrasing, and specificity of the original queries directly influence the quality and accuracy of schema linking. Some examples of paraphrased NL queries based on the SQL associated with the example above and the associated SQL schema may be as follows:
1) What car manufacturers produced models in 1970?
2) Which car makers have models associated with vehicles from the year 1970?
3) What are the names of car makers that produced cars in 1970?
4) Can you list the car manufacturers whose models were released in 1970?
5) Which makers are associated with car models from 1970 according to the database records?

In an embodiment, the system passes the original NLQ and the paraphrased NLQs to a score annotator (Operations 535 and 540). The annotator can be an ML model, specialized or fine-tuned, an agent, or a human. The annotator is responsible for evaluating the semantic similarity between the original NLQ and the paraphrased NLQs and assigning a score to paraphrased queries based on similarity to the original query. The scores can be used to rank the paraphrased queries in terms of their quality and relevance as well as select the most appropriate query for execution. The use of multiple paraphrased queries allows for greater flexibility and robustness in NLP tasks, for it reduces the reliance on a single, potentially ambiguous query and increases the chances of finding a suitable match for the intended meaning. However, a single, paraphrased NLQ may be used.

In an embodiment, the system generates a semantic similarity CS (Operation 545). Model-based evaluators/annotators or human evaluators assess semantic similarity, generating CSs to adjust accuracy for robust evaluation. The CSs help to determine the quality of the paraphrased queries and their ability to accurately convey the intended meaning of the original NLQ. The use of CSs allows for a more nuanced evaluation of the paraphrased queries, for it takes into account the degree of similarity between the original and paraphrased queries rather than simply relying on a binary classification of whether the paraphrased query is correct or incorrect. This can help to improve the overall performance and reliability of the system, particularly in situations where the original NLQ is ambiguous or difficult to understand.

In an embodiment, the system passes the paraphrased NLQs to an NL-to-SQL model (Operation 550). The result is the generation of an RTSQL query.

In an embodiment, the system generates an execution match accuracy (A) score (Operation 555). There are multiple ways of checking query accuracy. For example, the system may execute the RTSQL query on the database and compare the results to the execution results of the original “gold” SQL query. Another way to check query accuracy is to compare the expected results of the paraphrased queries to the expected results of the original “gold” SQL query without executing the queries on the database. This can be done by using a set of predefined expected results or by using a set of test data to generate the expected results. The choice of method will depend on the specific requirements and constraints of the system as well as the nature of the queries being evaluated. Regardless of the method used, the comparison allows the system to evaluate the model's ability to correctly interpret and execute NLQs and identify any linking errors or other issues that may arise during the translation process. The use of RTSQL queries can help to improve the accuracy and robustness of the model, for it provides a more realistic and accurate test of the model's performance without linking errors.

In an embodiment, the system generates a true accuracy metric using the confidence score and the accuracy score (Operations 560 and 565). The system evaluates performance degradation by comparing accuracy on paraphrased queries (Aₚₐᵣₐ) against original queries (A_{orig}). The system measures accuracy using execution match (EM) accuracy that evaluates if the SQL query execution result matches the result of the gold SQL query when executed on the same database. EM accuracy is widely regarded as a more robust metric than string-based comparisons because it directly reflects if the generated SQL produces the correct output regardless of syntactic differences. This makes it particularly suitable for evaluating NL-to-SQL systems, where queries may vary in structure but yield identical results.

In an embodiment, to quantify performance degradation, the system computes the accuracy drop as Δ_{acc}=A_{orig}−Aₚₐᵣₐ, where A_{orig} and Aₚₐᵣₐ represent the execution match accuracies on the original and paraphrased queries, respectively. The paraphrased queries are expected to preserve semantic equivalence with the original NLQs. To account for this, the system may incorporate annotator evaluations of paraphrase quality. Annotators that may be ML-based agents, other ML models, or humans, assess the semantic similarity between the original and paraphrased queries and provide CSs on a scale of 0 to 1, where higher scores indicate greater similarity. The system uses these confidence scores to adjust the measured accuracy, accounting for potential paraphrasing errors by using the following measurement:

Aₜᵣᵤₑ=Aₚₐᵣₐ±(1−CS)·A_{para.}

In an embodiment, this adjustment ensures that errors arising from paraphrasing artifacts do not unfairly penalize model performance, providing a more reliable evaluation of robustness to linguistic variations. By combining execution match accuracy with human-validated paraphrase quality, this approach provides a rigorous framework for analyzing model sensitivity to variations in query phrasing, enabling reliable assessments in NL-to-SQL tasks.

In an embodiment, the system stores the various queries and scores in an SQL database or other storage device (Operation 570) and uses the training data to train or fine-tune the NL-to-SQL model (Operation 575).

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

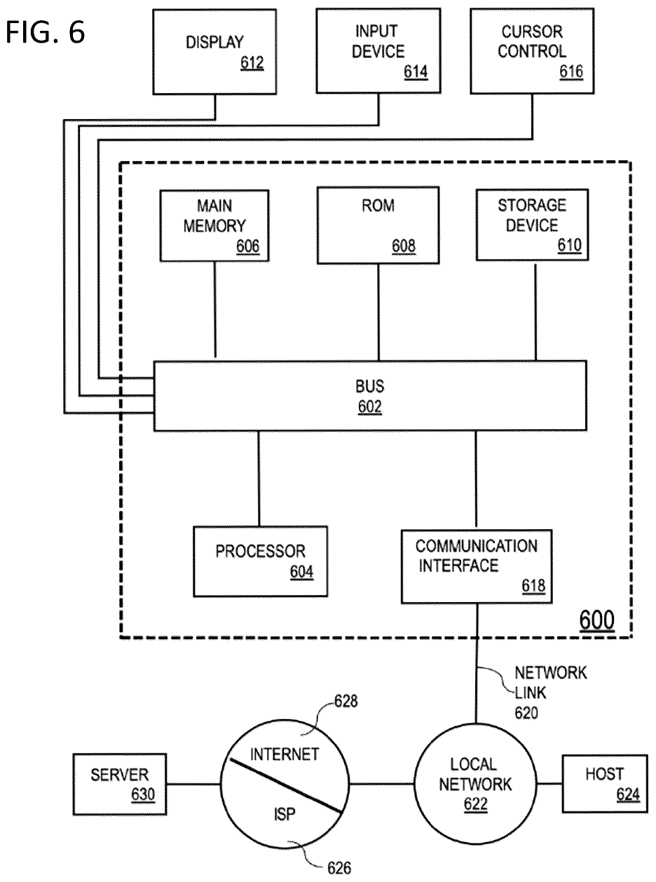

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
receiving, at a first machine learning model, a request to generate a natural language query;
wherein the request comprises a reference SQL query and identifies a target schema; and
determining one or more schema elements corresponding to the target schema; and
based at least in part on the reference SQL query and the one or more schema elements, generating a schema-aligned natural language query corresponding to the target schema; and
wherein the method is performed by at least one device including a processor.

2. The method of claim 1, wherein the step of determining the one or more schema elements corresponding to the target schema comprises determining the one or more schema elements based at least in part on the reference SQL query.

3. The method of claim 1, wherein the operations further comprise:
based on a mapping between the reference SQL query and the schema-aligned natural language query, modifying an SQL query generation process that generates SQL queries to be executed on a database associated with the target schema.

4. The method of claim 1, wherein the schema-aligned natural language query includes one or more natural language query elements that correspond to schema elements of the one or more schema elements.

5. The method of claim 1, wherein the operations further comprise:
applying the schema-aligned natural language query and a reference natural language query to a language model to generate a similarity score that indicates a level of semantic overlap between the schema-aligned natural language query and the reference natural language query;
determining, using the similarity score, that the schema-aligned natural language query is an acceptable paraphrase of the reference natural language query; and
applying the schema-aligned natural language query to a converter to generate an RTSQL query.

6. The method of claim 5, wherein the operations further comprise:
determining that the RTSQL query substantially matches the reference SQL query; and
performing one or more of:
a) responsive to determining that the RTSQL query substantially matches the reference SQL query, executing an error clearance process; and
b) responsive to determining that the RTSQL query substantially matches the reference SQL query, adding the schema-aligned natural language query to an evaluation dataset.

7. The method of claim 5, wherein the operations further comprise:
responsive to determining that the RTSQL query does not substantially match the reference SQL query, initiating a remediation process.

8. The method of claim 1, wherein the operations further comprise:
applying the schema-aligned natural language query and a reference natural language query to a language model to generate a similarity score that indicates a level of semantic overlap between the schema-aligned natural language query and the reference natural language query;
determining, using the similarity score, that the schema-aligned natural language query is not an acceptable paraphrase of the reference natural language query;
modifying the first machine learning model to produce a modified machine learning model in response to determining that the schema-aligned natural language query is not an acceptable paraphrase of the reference natural language query; and
based at least in part on the reference SQL query and the one or more schema elements, the modified machine learning model generating a post-modification schema-aligned natural language query corresponding to the target schema.

9. The method of claim 8, wherein the first machine learning model and the language model are the same model.

10. The method of claim 1, wherein the operations further comprise:
generating a training dataset that maps a plurality of schema-aligned natural language queries to corresponding SQL queries by:
selecting a first set of SQL queries and a first set of corresponding target schemas;
applying each SQL query of the first set of SQL queries and one or more corresponding schemas from the first set of corresponding target schemas to the first machine learning model to generate a first set of schema-aligned natural language queries; and
storing a mapping that includes a plurality of mapping entries, wherein each mapping entry comprises a) a subject schema-aligned natural language query from the first set of schema-aligned natural language queries, and b) a corresponding SQL query from the first set of SQL queries.

11. The method of claim 10, wherein the operations further comprise storing, in the mapping, a complexity metric that indicates the complexity of one or more of the SQL queries stored in the mapping.

12. The method of claim 11, wherein the complexity metric for each mapping entry in the mapping is based at least in part on a number of joins identified in the SQL query corresponding to the mapping entry.

13. The method of claim 11, wherein the operations further comprise:
modifying the first machine learning model to produce a modified machine learning model, wherein modifying the first machine learning model comprises:
wherein the training dataset identifies SQL queries as input and NL queries as output;
training the first machine learning model using the training dataset; and
wherein the first machine learning model is configured to generate natural language queries from SQL queries.

14. The method of claim 11, wherein the operations further comprise:
modifying a second machine learning model to produce a modified machine learning model, wherein modifying the second machine learning model comprises:
wherein the training dataset identifies NL queries as input and SQL queries as output;
training the second machine learning model using the training dataset; and
wherein the second machine learning model is configured to generate SQL queries from natural language queries.

15. The method of claim 11, wherein the operations further comprise:
modifying a second machine learning model to produce a modified machine learning model, wherein modifying the second machine learning model comprises modifying hyperparameters associated with the second machine learning model.

16. The method of claim 1, wherein at least one schema element of the one or more schema elements specifies a data structure and defines relationships among data fields relevant to the reference SQL query.

17. The method of claim 16, wherein the step of generating the schema-aligned natural language query comprises:
identifying data fields relevant to the reference SQL query; and
adding one or more identified data fields into the schema-aligned natural language query.

18. The method of claim 17, wherein the step of identifying data fields relevant to the reference SQL query comprises:
identifying one or more data fields that serve as key fields using the one or more schema elements; and
wherein the key fields correspond to primary keys or foreign keys associated with one or more database tables referenced in the reference SQL query.

19. One or more non-transitory computer readable media comprising instructions which, when executed by one or more hardware processors, cause performance of operations comprising:
receiving, at a first machine learning model for SQL-to-NL conversion and NL-to-SQL conversion, a request to generate a natural language query;
wherein the request comprises a reference SQL query and identifies a target schema; and
determining one or more schema elements corresponding to the target schema; and
based at least in part on the reference SQL query and the one or more schema elements, generating a schema-aligned natural language query corresponding to the target schema;
applying the schema-aligned natural language query to the first machine learning model to generate a RTSQL query.

20. A system comprising:
at least one device including a hardware processor;
the system being configured to perform operations comprising:
receiving, at a first machine learning model, a request to generate a natural language query;
wherein the request comprises a reference SQL query and identifies a target schema; and
determining one or more schema elements corresponding to the target schema; and
based at least in part on the reference SQL query and the one or more schema elements, generating a schema-aligned natural language query corresponding to the target schema, wherein the schema-aligned natural language query uses schema-specific terminology that explicitly or implicitly references one or more schema elements.
